(19) United States
(12) Patent Application Publication
(10) Pub. No.: US 2014/0144831 A1
(43) Pub. Date: May 29, 2014

(54) Filter Top Shell,Filter and Method for Manufacturing a Filter Top Shell

(71) Applicant: ZF Friedrichshafen AG, Friedrichshafen (DE)

(72) Inventors: Marco Rosendahl, Rieste (DE); Jan Duetz, Wangerland (DE)

(73) Assignee: ZF Friedrichshafen AG, Friedrichshafen (DE)

(21) Appl. No.: 14/054,622

(22) Filed: Oct. 15, 2013

(30) Foreign Application Priority Data
Nov. 26, 2012 (DE) 102012221555.7

(51) Int. Cl. F16H 57/04; B01D 35/30

(52) U.S. Cl. CPC F16H 57/0404; B01D 35/30
USPC 210/416.5; 264/271.1

(57) ABSTRACT

A filter top shell for an oil filter arranged in a transmission of a motor vehicle, having a pressure conduit arranged on a top side of the filter top shell, and wherein the pressure conduit generates a pressure boost to support a suction power of a pump connected to the filter, and wherein the pressure conduit is formed integrally with the filter top shell. Also proposed is an oil filter for a transmission of a motor vehicle, wherein the filter has a housing with a filter top shell having a pressure conduit and a filter bottom shell connectable thereto. Further, a method for producing a filter top shell for an oil filter arranged in a transmission of a motor vehicle, with an injection-molding process, wherein the filter top shell and a pressure conduit arranged on a top side of the filter top shell are integrally formed.

### BACKGROUND OF THE INVENTION

(1) Field of the Invention

The invention relates to a filter top shell according to the preamble of claim 1, a filter according to the preamble of claim 6 and a method of manufacturing a filter top shell according to the preamble of claim 7

In transmissions of motor vehicles, it is necessary to clean the transmission oil using a filter. A pump is usually provided for transporting the transmission oil flow through the filter. To improve the flow rate of the transmission oil, it is known in the art to additionally provide so-called intake charging on the pump or on the filter disposed thereon. The Venturi effect can here be exploited for suctioning the transmission oil into the filter, by providing on the filter a pressure line, through which the transmission oil is transported, wherein the outlet of the pressure line is arranged on the suction side of the pump and is in fluid communication with the transmission oil to be transported or with a suitable filter housing so as to suction the oil via a dynamic vacuum.

(2) Description of Related Art

Such a pump and filter unit with intake charging for transmissions or internal combustion engines is known for example from DE 10 2009 050 330 A1. A transmission oil filter housing has a suction conduit connectable to a suction pump. Furthermore, an intake flow charging device with a pressure conduit is provided on the transmission oil filter unit.

Typically, the pressure conduit is made of plastics and attached to a filter housing, which is likewise made of plastic, by welding. For this purpose, a type of lid forming a conduit, namely the pressure conduit, is welded into the top filter top shell of the filter housing. The pressure conduit is subjected to pressures between 8 and 20 bar during operation of the pump or the filter. The welding connection can therefore be overstressed by the high pressure load. The weld is a weak spot, which is unable to withstand the aforementioned high loads due to the properties of the plastic material. The filter or the filter housing may therefore be damaged as a result.

It is therefore an object of the present invention to provide a filter top shell made of plastic for a filter of the aforementioned type which is able to better withstand the high pressure loads. Furthermore, it is also an object of the present invention to provide a method for simple and inexpensive production of such a filter top shell.

### BRIEF SUMMARY OF THE INVENTION

This object is achieved by a filter top shell with the features according to claim a filter with the features of claim 6 and by a method for manufacturing a filter top shell with the features of claim 7. Preferred embodiments of the invention are recited in the dependent claims.

A filter top shell is provided, in particular for an oil filter or for a suitable filter housing arranged in a transmission of a motor vehicle, wherein a pressure conduit is arranged on a top side of the filter top shell, wherein the pressure conduit provides a pressure boost to assist the suction in the intake region of a filter pump connected to the filter, wherein the pressure conduit is formed integrally with the filter top shell.

The proposed, integral, one-piece design of the filter top shell with the pressure conduit eliminates potential weak spots that occur for example when these two parts are subsequently joined by welding. The so-formed pressure conduit, i.e. the entire filter top shell, can withstand the stress caused by the high pressure, thus effectively preventing a failure of the entire component. Moreover, the integral structure is advantageous in view of the production cost, since the additional process step for connecting the pressure conduit with the separately produced filter top shell is eliminated.

According to a preferred embodiment, the filter top shell and the pressure conduit integral therewith are made of a fiber-reinforced plastic material, in particular and without limitation of PA66 GF30 or GF30 PA6 (polyimide). This material gives the filter top shell and the pressure conduit disposed thereon particularly high strength and can also be easily processed.

According to another preferred embodiment, the pressure conduit has a suction side with an inlet opening and a pressure side with an outlet opening, wherein an orifice, in particular a nozzle, is disposed on the outlet opening, preferably form-locked and/or removable. The flow of injected oil can be selectively controlled by the nozzle, so that the desired Venturi effect can be achieved and optimized.

Preferably, the orifice is sealed with respect to the pressure conduit, in particular in the axial direction, by an O-ring or by a seal overmolded on the outlet port.

Preferably, the pressure conduit has a substantially circular cross section. This is advantageous in regard to the pressure conditions and pressure loads. However, the pressure conduit may also be oval or have a different cross-sectional geometry, for example in view of limited installation space requirements.

Moreover, fastening means for fastening the nozzle may advantageously be provided on the filter top shell. This simplifies the attachment of the orifice to the pressure conduit and to the filter top shell. Preferably, the fastening means are configured so as to enable subsequent replacement of the orifice/nozzle.

Furthermore, a filter, in particular an oil filter for a transmission of a motor vehicle is provided, wherein the filter has a housing with a filter top shell having a pressure conduit according to the above embodiments and a filter bottom shell connected thereto. The filter has the advantages already discussed above.

Furthermore, a method for manufacturing a filter top shell, in particular for an oil filter arranged in a transmission of a motor vehicle, by an injection molding process is provided, wherein the filter top shell and a pressure conduit arranged on a top side of the filter top shell are integrally formed. The method allows inexpensive and simple manufacture of a stable filter top shell with intake charging function.

Preferably, a fluid injection technique (FIT/GIT/WIT) is used for manufacturing the filter top shell. During injection molding, the region of the molded part forming the pressure conduit is advantageously initially completely filled with a plastic melt, in particular a thermoplastic plastic melt. The plastic melt is subsequently partially removed, prior to curing, by applying gas pressure or water pressure (fluid pressure) from the region where the pressure conduit will be formed. The beginning and the end of the pressure conduit, or the outlet and the inlet, must be provided with well-defined inner contours, since these are required in particular for sealing purposes. To this end, an injector tool shaping the intake-side inner contour is inserted into the inlet of the conduit region. The exhaust-side inner contour is formed analogously. The wall thickness of the pressure conduit remaining after the fluid has been injected and the melt has been expelled may vary slightly along its length, as long as a required minimum thickness is maintained, which is well within the skill of an artisan. Finally, the nozzle or orifice is connected at the outlet of the pressure conduit, which is preferably sealed with respect to the rest of the pressure conduit by an O-ring or by a seal applied for example with the 2K-sealing method or the like.

### BRIEF DESCRIPTION OF THE SEVERAL VIEWS OF THE DRAWING(S)

In the following, embodiments of the invention will be described in greater detail with reference to the appended drawing, which shows in:

FIGS. 1A-1E respective views of a filter top shell according to one embodiment;

FIG. 2 a section through the filter top shell of FIGS. 1A-1E in the region of the outlet; and

FIG. 3 a front view of the outlet the filter top shell shown in FIGS. 1A-1E.

### DETAILED DESCRIPTION OF THE INVENTION

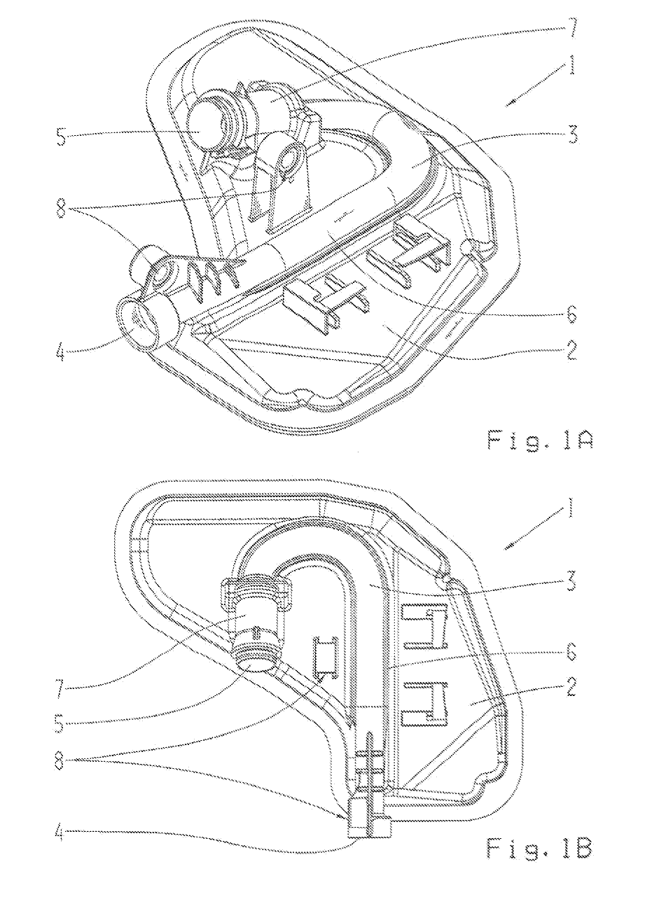

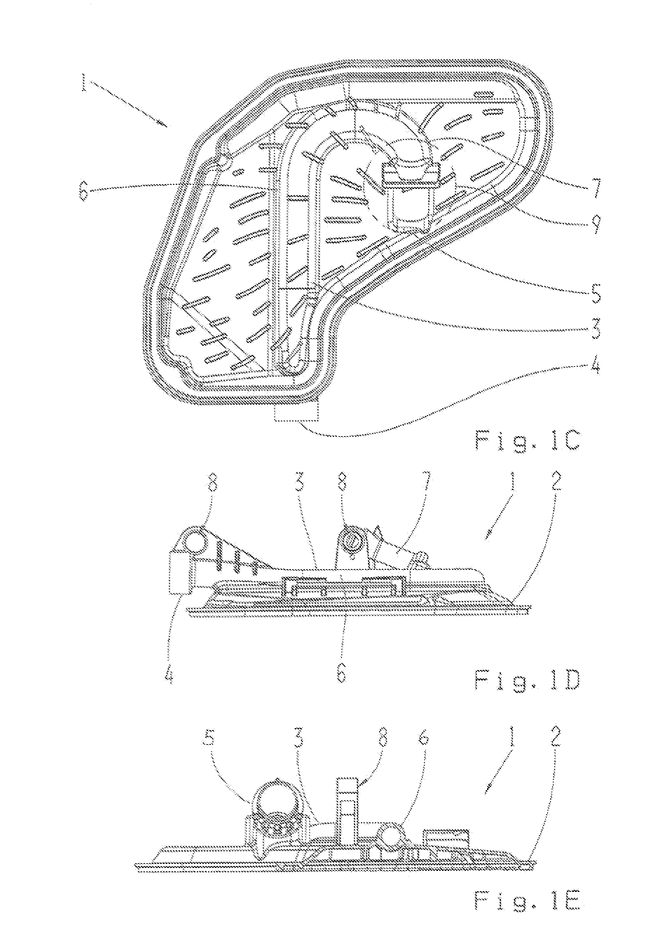

FIGS. 1A to 1E each show views of a filter top shell 1 of a transmission oil filter according to one embodiment. FIG. 1A shows an isometric view of the filter top shell 1,

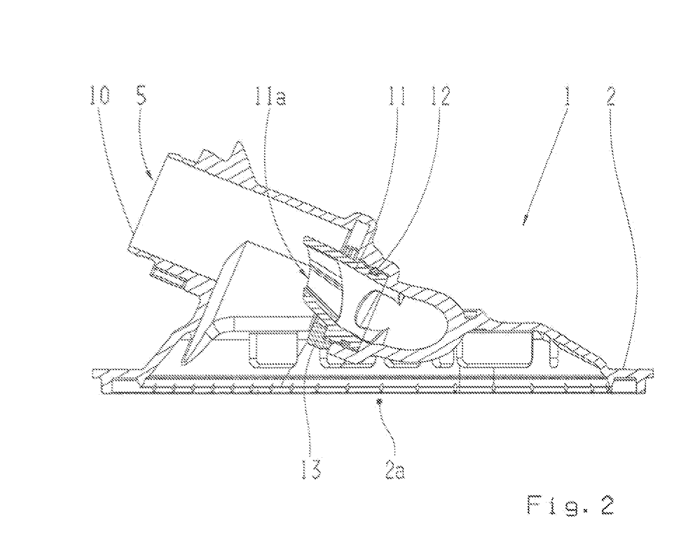

FIG. 1B shows a plan view of the filter top shell 1, FIG. 1C shows a view of the filter top shell 1 from below, FIG. 10 shows a side view, and FIG. 1E shows a partial sectional view of the filter top shell from the front. The filter top shell 1 is made of a plastic material, preferably glass-fiber-reinforced polyamide (PA GF). A pressure conduit 3 with a circular cross-section is integrally formed with the filter top shell 1 on a top side 2 of the filter top shell 1. The pressure conduit 3 provides intake flow charging to improve the filtering effect and has for this purpose an inlet 4, where a fluid or the transmission oil enters the pressure conduit 3, and an outlet 5, where the transmission oil transported through the pressure conduit 3 exits again or enters the suction side of an (unillustrated) pump. The pressure conduit 3 has is substantially U-shaped. A first leg 6 of this U-shaped pressure conduit, where the inlet 4 is located, extends here substantially parallel to the top side 2 of the filter top shell 1, or in the same plane as the filter top shell 1. Conversely, the second leg 7 of the U-shaped pressure conduit is slightly angled upwardly and away from the top side 2, so that the outlet 5 does not rest directly on the top 2 of the filter top shell 1. Furthermore, a sleeve-like attachment device 8 is disposed on the inlet 4. Another sleeve-like attachment device 8 is disposed directly on the top side 2 of the filter top shell 1. The entire filter can be attached with the attachment devices 8 at a predetermined position. The attachment devices 8 may also be formed integral in one piece with the filter top shell. An orifice or a nozzle is arranged at the outlet 5, as will be described below in conjunction with FIG. 2. The region 9, where the nozzle is attached to the filter top shell 1, as indicated in FIG. 1C by a circle.

As already discussed, the filter top shell 1 is manufactured using fluid injection technique (FIT), specifically gas injection technique (GIT), without restricting the invention to a particular of these methods. During injection molding, the region forming the pressure conduit 3 is first completely filled with a plastic melt, which is then, before the plastic melt has cured, removed from the region of the pressure conduit or blown out from the inside of the region of the pressure conduit with gas pressure or water pressure (generally fluid pressure). Because the beginning and the end of the pressure conduit or the outlet 5 and the inlet 4 must be provided with precisely defined interior contours, which is required in particular for sealing purposes as well as for the subsequent connection to respective functional units and/or line parts, an injector tool is inserted, for example, at the inlet 4 of the pressure conduit 3, which forms the inlet-side inner contour and at the same time ensures the entry of fluid. The exhaust-side inner contour is formed similarly. The reverse procedure (injector tool at the outlet 5) is also feasible. The wall thickness of the remaining pressure conduit may vary slightly along its extent, as long as the required minimum thickness is maintained. Lastly, the nozzle 11 or the orifice (see FIG. 2) are connected to the outlet 5 of the pressure conduit 3, which is sealed from the remaining pressure conduit 3 by an O-ring 12 (see FIG. 2) or by a seal applied with, for example, the 2K-process (two-component process)

FIG. 2 is a section through the filter top shell 1 illustrated in FIGS. 1A to 1E in the region of the outlet 5. As can be seen here, an orifice in the form of a nozzle 11 is inserted in an opening 10 of the outlet 5, which is sealed relative to the pressure conduit 3 with an O-ring 12. Fastening means 13 in the form of clamps or locking structures are provided on the filter top shell 1 for releasably attaching the nozzle 11.

The nozzle 11 has in the region of the nozzle opening 11a a shape that is specifically designed to achieve the desired Venturi effect, which will not be described here in detail.

As further seen from the sectional view in FIG. 2, the pressure conduit 10 opens upstream of its outlet 5 and downstream of the nozzle 11 or the nozzle opening 11a into the interior of the filter housing, i.e. into the space below the filter top shell 1; this space is indicated symbolically in FIG. 2 with the reference numeral 2a. This can also be seen in the diagram of FIG. 1C in the region of the circle having the reference numeral 9. In this way, the medium contained in the region 2a is then suctioned in the aforementioned region area between the outlet 5 of the pressure conduit and the nozzle 11. The strength of this effect can be influenced by the particular shape and arrangement of nozzle 11, wherein the nozzle 11 is advantageously detachably or interchangeably connected with the filter top shell 2 by a suitable design of the fastening means 13.

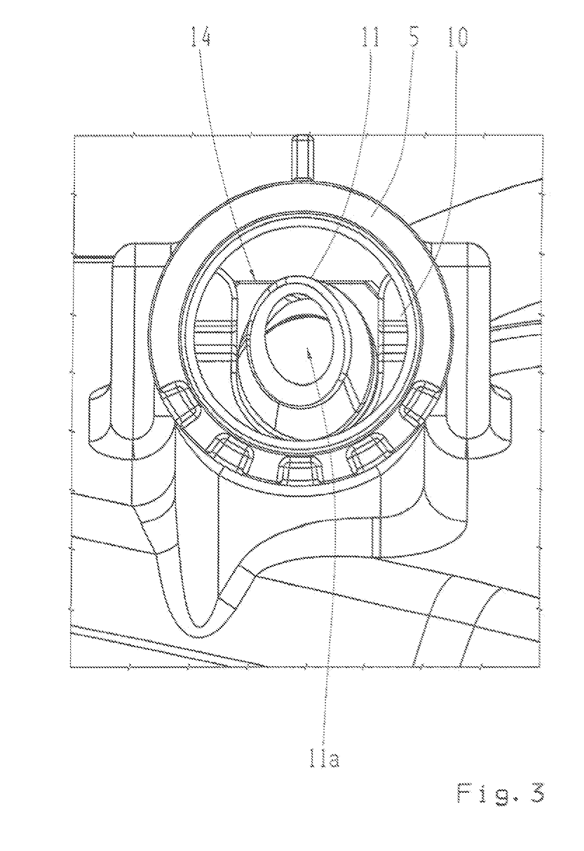

FIG. 3 is a front view of the outlet 5 of the filter top shell 1 shown in FIGS. 1A to 1E and 2. As is apparent here, a rotation lock 14 is provided in the outlet 5 in the region of the nozzle 11 by a corresponding form fit, so that the nozzle 11 remains securely in its intended installation position, even under high applied pressure (see FIG. 2).

### REFERENCE NUMERALS

1 Filter top shell
2 Top side
2a Interior space
3 Pressure conduit
4 Inlet
5 Outlet
6 first leg of the U-shape
7 second leg of the U-shape
8 Attachment devices
9 Region
10 Orifice
11 Nozzle
11a Nozzle opening
12 O-ring
13 Fastening means
14 Rotation lock

1. An oil filter top shell (1), arranged in a transmission of a motor vehicle,
comprising a pressure conduit (3) arranged on a top side (2) of the filter top shell (1),
wherein the pressure conduit (3) generates a pressure boost to support a suction power of a filter pump connected to the filter,
wherein the pressure conduit (3) is formed integrally with the filter op shell (1).

2. The filter top shell (1) according to claim 1, wherein the filter op shell (1) and the pressure conduit (3) are made of a fiber reinforced plastic.

3. The filter top shell (1) according to claim 1, wherein the pressure conduit (3) comprises a suction side with an inlet opening (4) and a pressure side with an outlet opening (5), wherein an orifice (110) is arranged on the outlet opening (5), preferably in a form-fitting manner.

4. The filter top shell (1) according to claim 3, wherein the orifice (11) is axially sealed against the pressure conduit (3), particularly by an O-ring (12) or a seal overmolded on the outlet opening (5).

5. The filter top shell (1) according to claim 3, further comprising fastening means (13) disposed on the top filter top shell (1) for detachable attachment of the orifice (11).

6. An oil filter for a transmission of a motor vehicle, wherein the oil filter comprises a housing with a filter top shell (1) having a pressure conduit (3) arranged on a top side (2) of the filter top shell (1),
wherein the pressure conduit (3) generates a pressure boost to support a suction power of a filter pump connected to the filter, and
wherein the pressure conduit (3) is formed integrally with the filter top shell (1).

7. A method for producing a filter top shell (1) for an oil filter arranged in a transmission of a motor vehicle, with an injection-molding process, comprising the steps of
providing integrally the filter top shell and a pressure conduit (3) on a top side (2) of the filter top shell (1).

8. The method according to claim 7, wherein the injection-molding process is a fluid injection technique, and a curing step.

9. The method according to claim 7, wherein during injection molding, a region of the pressure conduit (3) is completely filled with a molten plastic material.

10. The method according to claim 9, wherein, prior to curing the plastic melt, the plastic melt is partially removed from the region by gas pressure or water pressure in order to form the pressure conduit (3).

11. The filter top shell (1) according to claim 2, wherein the fiber reinforced plastic is PA66 GF30 or PA6 GF30.

12. The filter top shell (1) according to claim 3, wherein the orifice (11) is a nozzle (11) which is arranged on the outlet opening (5) in a form-fitting manner.

13. The filter top shell (1) according to claim 3, wherein the orifice (11) is axially sealed against the pressure conduit (3) by an O-ring (12) or a seal overmolded on the outlet opening (5).

14. The method according to claim 7, wherein the molten plastic material is a thermoplastic plastic melt.
